(19) United States
(12) Patent Application Publication
(10) Pub. No.: US 2022/0414540 A1
(43) Pub. Date: Dec. 29, 2022

(54) METHOD, DEVICE AND MEDIUM FOR DATA PROCESSING

(71) Applicant: NEC Corporation, Tokyo (JP)

(72) Inventors: Erli Wang, Beijing (CN); Lu Feng, Beiling (CN)

(73) Assignee: NEC Corporation, Tokyo (JP)

(21) Appl. No.: 17/832,086

(22) Filed: Jun. 3, 2022

(30) Foreign Application Priority Data
May 13, 2021 (CN) 202110521822.4

(51) Int. Cl. G06N 20/00

(52) U.S. Cl. CPC G06N 20/00

(57) ABSTRACT

Embodiments of the present disclosure relate to method, device and computer-readable storage medium for data processing. A method for data processing comprises: obtaining, based on similarities between characteristics of a first target dataset and characteristics of a predetermined dataset, a respective first performance of a plurality of candidate causal model configurations corresponding to characteristics of the predetermined dataset; selecting, based on the respective first performance, a target causal model configuration from the plurality of candidate causal model configurations; and processing the first target dataset using a causal model which is built based on the target causal model configuration. Embodiments of the present disclosure also provide device and computer-readable storage medium capable of implementing the above method. Besides, the embodiments of the present disclosure can adaptively build a good casual model.

### FIELD

Embodiments of the present disclosure relate to the field of data processing, and more specifically, to method, apparatus and computer-readable storage medium for data processing.

### BACKGROUND

Data volume expands rapidly along with the booming of the information technology. In such context and trend, data processing and analysis using machine leaning or artificial intelligence has attracted broad attention. Causal knowledge has been considered valuable to machine leaning or artificial intelligence. Once a causal model is obtained using causal analysis techniques, it can assist users to predict and make decisions about problems or targets reflected by data in a particular scenario, thereby improving or solving the problems bothering the users in that scenario.

### SUMMARY

Embodiments of the present disclosure provide method, apparatus and computer-readable storage medium for data processing.

In a first aspect of the present disclosure, there is provided a method for data processing. The method comprises: obtaining, based on similarities between characteristics of a first target dataset and characteristics of a predetermined dataset, a respective first performance of a plurality of candidate causal model configurations corresponding to characteristics of the predetermined dataset; selecting, based on the respective first performance, a target causal model configuration from the plurality of candidate causal model configurations; and processing the first target dataset using a causal model built based on the target causal model configuration.

In a second aspect of the present disclosure, there is provided a method for data processing. The method comprises: obtaining, based on similarities between a training dataset and a predetermined dataset, a respective second performance of a plurality of candidate causal model configurations corresponding to characteristics of the predetermined dataset; selecting, based on the respective second performance, a target causal model configuration from the plurality of candidate causal model configurations; determining a second performance metric resulted from applying a causal model to the training dataset, the causal model being built based on the target causal model configuration; and updating, based on the second performance metric, a second performance corresponding to the target causal model configuration.

In a third aspect of the present disclosure, there is provided a method for data processing. The method comprises: determining, based on similarities between characteristics of a first target dataset and one or more predetermined characteristics, a target data analysis model configuration, which is determined based on performance of a plurality of candidate data analysis model configurations; and processing the first target dataset using a target data analysis model built based on a target data analysis model configuration.

In a fourth aspect of the present disclosure, there is provided an apparatus for data processing. The apparatus comprises at least one processing unit and at least one memory.

The at least one memory is coupled to the at least one processing unit and stores instructions to be executed by the at least one processing unit. The instructions, when executed by the at least one processing unit, cause the apparatus to perform acts comprising: obtaining, based on similarities between characteristics of a first target dataset and characteristics of a predetermined dataset, a respective first performance of a plurality of candidate causal model configurations corresponding to characteristics of the predetermined dataset; selecting, based on the respective first performance, a target causal model configuration from the plurality of candidate causal model configurations; and processing the first target dataset using a causal model built based on the target causal model configuration.

In a fifth aspect of the present disclosure, there is provided an apparatus for data processing. The apparatus comprises at least one processing unit and at least one memory. The at least one memory is coupled to the at least one processing unit and stores instructions to be executed by the at least one processing unit. The instructions, when executed by the at least one processing unit, cause the apparatus to perform acts comprising: obtaining, based on similarities between a training dataset and a predetermined dataset, a respective second performance of a plurality of candidate causal model configurations corresponding to characteristics of the predetermined dataset; selecting, based on the respective second performance, a target causal model configuration from the plurality of candidate causal model configurations; determining a second performance metric resulted from applying a causal model built based on the target causal model configuration to the training dataset; and updating, based on the second performance metric, a second performance corresponding to the target causal model configuration.

In a sixth aspect of the present disclosure, there is provided an apparatus for data processing. The apparatus comprises at least one processing unit and at least one memory. The at least one memory is coupled to the at least one processing unit and stores instructions to be executed by the at least one processing unit. The instructions, when executed by the at least one processing unit, cause the apparatus to perform acts comprising: determining, based on similarities between characteristics of a first target dataset and one or more predetermined characteristics, a target data analysis model configuration, which is determined based on performance of a plurality of candidate data analysis model configurations; and processing the first target dataset using a target data analysis model built based on a target data analysis model configuration.

In a seventh aspect of the present disclosure, there is provided a computer-readable storage medium with machine-executable instructions stored thereon. The machine-executable instructions, when executed by a device, cause the device to perform the method according to the first aspect of the present disclosure.

In a eighth aspect of the present disclosure, there is provided a computer-readable storage medium with machine-executable instructions stored thereon. The machine-executable instructions, when executed by a device, cause the device to perform the method according to the second aspect of the present disclosure.

In a ninth aspect of the present disclosure, there is provided a computer-readable storage medium with machine-executable instructions stored thereon. The machine-executable instructions, when executed by a device, cause the device to perform the method according to the third aspect of the present disclosure.

This Summary section is provided to introduce a series of concepts in a simplified form that are further described below in the Detailed Description section. This Summary section is not intended to identify key features or essential features of the claimed subject matter, nor is it intended to be used to limit the scope of the claimed subject matter. Other features of the present disclosure will be understood more easily through the following description

### BRIEF DESCRIPTION OF THE DRAWINGS

Through the following description and the claims, the objectives, advantages and features of the present invention will become more apparent. For exemplary purposes alone, the drawings here provide non-restrictive description of the preferred embodiments. In the drawings:

FIG. 1 illustrates a schematic diagram of an example of a data processing environment in which some embodiments of the present disclosure can be implemented;

FIG. 2 illustrates a flow chart of an example training procedure in accordance with embodiments of the present disclosure;

FIG. 3 illustrates a flow chart of an exemplary use procedure in accordance with embodiments of the present disclosure;

FIG. 4 illustrates a flow chart of another exemplary use procedure in accordance with embodiments of the present disclosure;

FIG. 5 illustrates a schematic block diagram of an example computing device for implementing embodiments of the present disclosure;

In each drawing, same or corresponding reference signs indicate same or corresponding parts.

### DETAILED DESCRIPTION OF EMBODIMENTS

Embodiments of the present disclosure will be described in more details with reference to the drawings. Although the drawings illustrate some embodiments of the present disclosure, it should be understood that the present disclosure can be implemented in various manners and should not be interpreted as being limited to the embodiments explained herein. On the contrary, the embodiments are provided for a more thorough and complete understanding of the present disclosure. It should be understood that the drawings of the present disclosure and their embodiments are only for exemplary purposes and shall not restrict the protection scope of the present disclosure.

Throughout the description of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The terms “first”, “second” and so on can refer to same or different objects. The following text can comprise other explicit and implicit definitions.

The term “circuitry” used here may indicate hardware circuitry and/or combination of hardware circuitry and software. For example, the circuitry may be a combination of analog and/or digital hardware circuitry with software/firmware. As another example, the circuitry may be any part of a hardware processor provided with software, including digital signal processor(s), software and memories, wherein the digital signal processor(s), software and memories operate together, enabling an apparatus such as computing device and the like to operate to execute various functions. In a further example, the circuitry may be hardware circuitry and/or processor, e.g., microprocessor or a part of it, which may be operated by software/firmware. However, when the circuitry can operate without the software, the software may be omitted. As used herein, the term “circuitry” also covers the hardware circuitry or processor(s) alone, or part of it/them and implementations of software and/or firmware attached to it/them.

Causality-based decision making has drawn broad attention from both academia and industry. To this end, one may identify a causal model from a given dataset, and then adopt optimization techniques to compute the optimal strategy. Currently, different causal model (or modeling) methods have been proposed. However, It still remains an open and fundamental challenge as to how to select good causal model configurations (including causal model methods and parameters thereof). Currently, the causal model configurations are often manually selected and tuned based on personal experience. However, this is time-consuming, has a low applicability and is even unfeasible at some occasions.

Causal modeling and optimization generally includes procedures like data collection, data input, data processing, causal structure discovery and strategy execution. In data collection procedure, user datasets may be collected from log files and questionnaires. In data input procedure, the collected user datasets may be received. In data processing procedure, data cleaning and preprocessing are performed to improve the data quality. In causal structure discovery procedure, a causal model may be used to obtain a dataset-based causal relation. In strategy execution procedure, the optimal strategy is executed based on the causal relation, a feedback is received from the environment and the causal modeling and optimization process are iteratively performed in accordance with the new user dataset collected in response to the feedback.

It can be seen that causal modeling and optimization are mainly performed separately. However, the result of causal modeling directly affects the performance of strategy execution, and the feedback from the strategy execution leads to a better causal modeling. To this end, a systematic framework of deployable optimal intervention based on a causal model is required, which can automatically improve casual modeling and strategy execution over time.

Embodiments of the present disclosure provide a solution for data processing to solve one or more of the above issues and/or other underlying issues. In this solution, based on similarities between characteristics of a first target dataset and characteristics of a predetermined dataset, respective performance (hereinafter referred to as “first performance”) of a plurality of candidate causal model configurations corresponding to characteristics of the predetermined dataset is obtained; a target causal model configuration is selected from the plurality of candidate causal model configurations based on the respective first performance; and the first target dataset is processed using a causal model built based on the target causal model configuration.

In this way, an adaptive causal model configuration selector may be implemented to select a suitable causal model configuration, based on which a good causal model is built.

Various embodiments of the present disclosure are described in details below with reference to example scenarios in user service field. It is to be understood that this is provided for descriptive purposes only and is not intended to restrict the scope of the present invention in any manners.

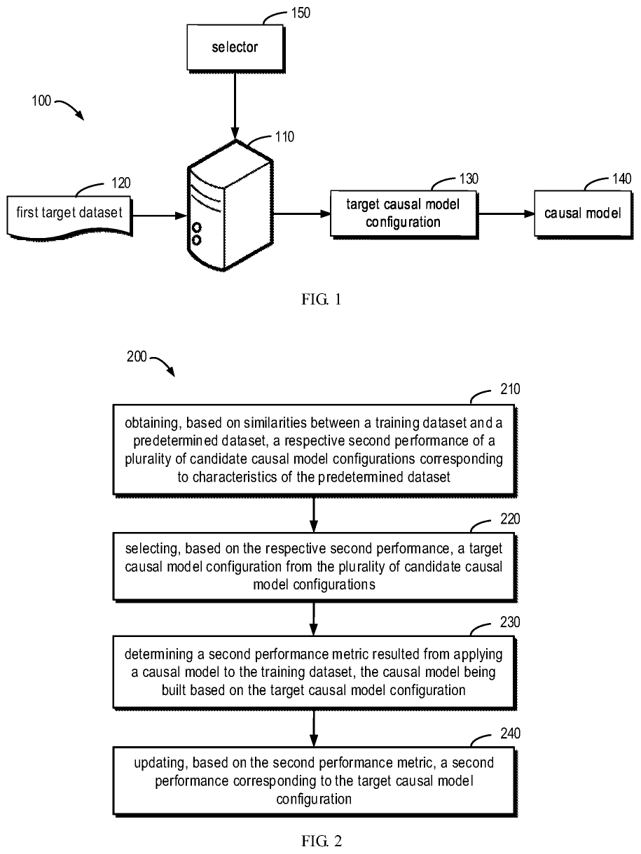

FIG. 1 illustrates a schematic diagram of an example of a data processing environment in which some embodiments of the present disclosure can be implemented. The environment 100 comprises a computing device 110. The computing device 110 may be any device with computing capabilities, such as personal computer, tablet computer, wearable device, cloud server, mainframe and distributed computing system etc.

The computing device 110 may obtain a first target dataset 120. The computing device 110 may select a target causal model configuration 130 based on the first target dataset 120. For example, the target causal model configuration 130 may be selected by a trained selector 150. Accordingly, the computing device 110 may build a casual model 140 based on the target causal model configuration 130, to process the first target dataset 120 using the causal model 140.

For example, in the user service field, the first target dataset 120 may be user dataset, including but not limited to one or more of behavior data related to the use of the product or service by the user, attribute data and research data (such as, age of the user, monthly online traffic consumption, rate of free traffic, total bills for monthly the online traffic consumption, information of satisfaction degree with product or service). As another example, in healthcare field, the first target dataset 120 may be patient dataset, including but not limited to, one or more of patient attribute data, medical test data and therapeutic scheme data (such as gender, age, occupation, therapeutic scheme and efficacy of the patient etc.). The computing device 110 may determine, based on the above user dataset, the target causal model configuration 130, such as causal model method and parameters thereof.

For example, the casual model method may include but not limited to PC (Peter-Clark Algorithm), GES (Greedy Equivalent Search), LinGAM (Linear non-Gaussian Model) and CAM (Causal Additive Model) etc.

Accordingly, the parameters of the causal modeling method may include algorithm parameters (such as maxDegree, m.Max) and computing resources (like numCores etc.) of the GES, wherein maxDegree may represent vertex degree of a cause and effect diagram, including inflow side and outflow side; and m.Max may indicate the maximum number of conditional independence test. The result gets more accurate as more tests are run. The numCores may denote the number of cores for parallelly estimating the framework. The computing speed accelerates when more cores are employed.

In addition, the parameters may include alpha of a PC etc., where alpha may represent a significance level in (0, 1) of each conditional independence test. In general, a small alpha tends to generate a sparse cause and effect diagram. The parameters may also include scoreName and maxNumParents of CAM, the scoreName representing a selection for “SEMGAM” or “SEMLIN”. “SEMGAM” assumes a general additive model type, while “SEMLIN” fits a linear model. maxNumParents may indicate the maximum number of parent node. The incoming edge of the current node points from the parent node to the current node.

It should be appreciated that the above causal model method and parameters are no more than examples. Embodiments of the present disclosure can apply to any suitable causal model configurations currently existing and to be developed in the future.

Therefore, the computing device 110 may build a causal model 140 based on the target causal model configuration 130, to process the first target dataset 120 using the causal model 140. For example, the causal model may help determine how to intervene the user service strategy, thus improving user satisfaction.

In some embodiments, it is required to train the selector 150 of the causal model configuration before implementing the above procedure. It should be understood that the selector 150 may be trained by the computing device 110 or any other suitable devices external to the computing device 110. The trained selector 150 may be deployed in the computing device 110 or external to the computing device 110. An exemplary training procedure is described below with reference to an example in which the selector 150 is trained by the computing device 110 as shown in FIG. 2.

FIG. 2 illustrates a flow chart of an example training procedure 200 in accordance with embodiments of the present disclosure. For example, the method 200 may be executed, by the computing device 110 shown in FIG. 1. It should be understood that the method 200 also may include additional blocks not shown and/or omit some blocks already shown. The scope of the present disclosure is not restricted in this regard.

At block 210, the computing device 110 obtains, based on similarities between a training dataset and a predetermined dataset, a respective performance (hereinafter referred to as “second performance”) of a plurality of candidate causal model configurations corresponding to characteristics of a predetermined dataset. The second performance will be described in details below.

In some embodiments, in order to gain the corresponding second performance, the computing device 110 may obtain a training dataset. Similar to the target dataset, the training dataset in the user service field may be a user dataset, including but not limited to one or more of behavior data related to the use of the product or the service by the user, attribute data and research data (e.g., age of the user, monthly online traffic consumption, rate of free traffic, total bills for monthly online traffic consumption and information of satisfaction for product or service etc.). As an example, the training dataset in the healthcare field may be patient dataset, including but not limited to one or more of patient attribute data, medical test data and therapeutic scheme data (such as gender, age, occupation, therapeutic scheme and efficacy of the patient).

Then, the computing device 110 may determine characteristics of the training dataset. In some embodiments, such characteristics include statistical characteristics and/or distribution characteristics of the training dataset in one or more categories. For example, characteristics of the training dataset may contain ratio of binary data (e.g., “Male or Female”, “Yes or No” and “True or False” etc.) in the training dataset, ratio of continuous data (such as temperature and humidity etc.) in the training dataset, ratio of sequencing data (e.g., rank and the like) in the training dataset, and ratio of categorical data (such as “Spring/Summer/Autumn/Winter” and “Cat/Dog” etc.) in the training dataset, characteristic dimensionality (such as 5-dimension and 100-dimension etc.) of the training dataset, sample count (such as 200 samples and 10000 samples etc.) in the training dataset, ratio of missing data in the training dataset, balance of target factor values in the training dataset (for example, if the entire satisfaction samples include 90 satisfactory samples and 10 unsatisfactory samples, it indicates a low balance; however, if 51 out of the entire satisfaction samples are satisfactory samples and 49 are unsatisfactory samples, the balance is high), structure characteristics built from the training dataset (e.g., interaction item characteristics (such as old male that previously worked in government derived from age, gender and occupation)), transformation characteristics of the original characteristics (e.g., via extraction of a root, absolute value or other functional transformations), skewness and/or kurtosis of the training dataset (such as skewness and/or kurtosis of normal distribution and Poisson distribution), mean values of the training dataset, and variance of the training dataset etc. Characteristics also may further include characteristics of application fields or application environments of the training dataset.

Next, the computing device 110 may determine the characteristics of the training dataset based on a predetermined rule. The predetermined rule may indicate how to extract features. For example, the predetermined rule may indicate the ratio of binary data, characteristic dimensionality, sample count and ratio of missing data extracted from the training dataset. In such case, the extracted characteristics may be “{% binary=10%, |feature|=100, |sample|=10,000, % missingData=10%}”. This means the ratio of binary data is 10%, characteristic dimension is 100-dimension, sample count is 10,000 and ratio of the missing data is 10%. It should be appreciated that the predetermined rule may be any suitable rules, and may be configured by the computing device 110 or the user.

Then, the computing device 110 may determine corresponding similarities between the characteristics of the training dataset and the characteristics of a set of candidate predetermined datasets. For example, the computing device 110 may compute a distance (such as Hamming distance and Euclidean distance etc.) from the characteristics of the training dataset to the characteristic of each candidate predetermined dataset to determine the similarities. In some embodiments, the characteristics of a set of candidate predetermined datasets may be pre-stored in the characteristic library. Alternatively, the computing device 110 also may determine the respective similarities between the characteristics of the training dataset and the characteristics of a set of candidate predetermined datasets by extracting characteristics from the set of candidate predetermined datasets.

In some embodiments, the computing device 110 may further determine a characteristic function built from one or more characteristics and further employ the characteristic function to determine the similarities. For example, the characteristic function is “f (ratio of binary data, sample count)”. The computing device 110 may compute a distance from the characteristic function of the training data to the characteristic function of each candidate predetermined dataset to determine the similarities.

Moreover, the computing device 110 may select, from a set of candidate predetermined datasets, the candidate predetermined dataset having the highest similarities as a predetermined dataset. As such, the most similar predetermined dataset may be determined and the respective second performance of a plurality of candidate causal model configurations corresponding to the predetermined dataset is also obtained. In this way, a good causal model configuration is selected more rapidly for the causal modeling.

As an example, it is assumed that the characteristic of the candidate predetermined dataset 1 is “{% binary=80%, |feature|=10,000, |sample|=1000, % missingData=30%}” and the characteristic of the candidate predetermined dataset 2 is “{% binary=15%, |feature|=200, |sample|=10,000, % missingData=8%}”. In such case, the highest similarities is observed between the training dataset and the candidate predetermined dataset 2, so the candidate predetermined dataset 2 may be determined as the predetermined dataset.

In addition, an example of the respective second performance of a plurality of candidate causal model configurations corresponding to the characteristics of a set of candidate predetermined datasets is illustrated in Table 1 below:

TABLE 1

| | Causal Model Method 1 | | Causal Model Method 2 | |
|---|---|---|---|---|
| | Parameter 1 | Parameter 2 | Parameter 3 | Parameter 4 |
| Candidate | 0.1 | 0.5 | 0.1 | 0.3 |
| predetermined | | | | |
| dataset 1 | | | | |
| Candidate | 0.6 | 0.2 | 0.15 | 0.05 |
| predetermined | | | | |
| dataset 2 | | | | |

It is can be seen that, for the candidate predetermined dataset 1, the second performance of the causal model configuration (causal model method 1 and parameter 1) is 0.1, the second performance of the causal model configuration (causal model method 1 and parameter 2) is 0.5, the second performance of the causal model configuration (causal model method 2 and parameter 3) is 0.1 and the second performance of the causal model configuration (causal model method 2 and parameter 4) is 0.3. Similarly, for the candidate predetermined dataset 2, the second performance of the causal model configuration (causal model method 1 and parameter 1) is 0.6, the second performance of the causal model configuration (causal model method 1 and parameter 2) is 0.2, the second performance of the causal model configuration (causal model method 2 and parameter 3) is 0.15 and the second performance of the causal model configuration (causal model method 2 and parameter 4) is 0.05.

While the candidate predetermined dataset 2 is determined as the predetermined dataset, the respective second performance of a plurality of candidate causal model configurations corresponding to the candidate predetermined dataset 2 will be obtained. As stated above, for the candidate predetermined dataset 2, the second performance of the causal model configuration (causal model method 1 and parameter 1) is 0.6, the second performance of the causal model configuration (causal model method 1 and parameter 2) is 0.2, the second performance of the causal model configuration (causal model method 2 and parameter 3) is 0.15 and the second performance of the causal model configuration (causal model method 2 and parameter 4) is 0.05.

Besides, it should be understood that although Table 1 only demonstrates four causal model configurations and two candidate predetermined datasets, any suitable causal model configurations and candidate predetermined datasets are also feasible. In addition, although the second performance of each candidate predetermined dataset is normalized, i.e., the second performance of each causal model configuration is summed to 1, the second performance may also not be normalized.

In some embodiments, the candidate causal model configuration may be extensible. For example, the computing device 110 may add a predetermined causal model configuration into a plurality of candidate causal model configurations based on the number of times a plurality of candidate causal model configurations are used for building a causal model. For example, when a candidate causal model configuration is applied to build a causal model for 100 times, the candidate causal model configuration may be added as a new predetermined causal model configuration into a plurality of candidate causal model configurations.

Besides, in some embodiments, if the training dataset is not similar to any of a set of candidate predetermined datasets, e.g., the similarity between the training dataset and each of the set of candidate predetermined datasets is below a predetermined threshold (such as 0.5), then the computing device 110 may incorporate the characteristics of the training dataset to the characteristics of the set of candidate predetermined datasets. Furthermore, the computing device 110 may also set the second performance of a plurality of candidate causal model configurations corresponding to the characteristics of the training dataset as a predetermined second performance (e.g., the predetermined second performance may be 0).

For example, it is assumed that the characteristic of the training dataset is “{% binary=50%, |feature|=5,000, |sample|=2,000, % missingData=80%}”, the characteristic of the candidate predetermined dataset 1 is “{% binary=80%, |feature|=10,000, |sample|=1000, % missingData=30%}” and the characteristic of the candidate predetermined dataset 2 is “{% binary=15%, |feature|=200, |sample|=10,000, % missingData=8%}”. Since the characteristic of the training dataset is not similar to neither of the candidate predetermined dataset 1 nor the candidate predetermined dataset 2, i.e., the similarity between the characteristic of the training dataset and the characteristic of either the candidate predetermined dataset 1 or the candidate predetermined dataset 2 is below the predetermined threshold, the characteristic of the training dataset may be added into the characteristic of the set of candidate predetermined datasets, e.g., as candidate predetermined dataset 3.

In this way, diversity of the set of candidate predetermined datasets is automatically increased. As the causal model is built or trained for more times, different types of various candidate predetermined datasets may be obtained.

Moreover, in some embodiments, the predetermined threshold may vary with the number of times the causal model is built or trained. To this end, the computing device 110 may determine the number of times a plurality of candidate causal model configurations is applied to build the causal model, and determine a predetermined threshold based on the determined number of times. For example, the predetermined threshold may increase along with the number of times, such that a similar predetermined dataset may be more easily found at the beginning Alternatively, the predetermined threshold may decrease along with the number of times, such that diversity of the set of candidate predetermined datasets is more efficiently added at the beginning.

At block 220, the computing device 110 selects, based on the respective second performance, a target causal model configuration from a plurality of candidate causal model configurations. For example, the candidate causal model configuration having the highest second performance may be selected as the target causal model configuration. As mentioned above, among the four candidate causal model configurations, the candidate causal model configuration (causal model method 1 and parameter 1) has the highest second performance of 0.6 and therefore is selected as the target causal model configuration. For example, the target causal model configuration may be “{alg=‘GES’, ‘maxDegree’=2}”, “{alg=‘PC’, ‘alpha’=0.2, ‘numCores’=2}” and the like.

At block 230, the computing device 110 decides a second performance metric derived by applying a causal model to the training dataset, where the causal model is built based on a target causal model configuration. For example, the second performance metric includes category precision, recall rate and/or F1 score etc. At block 240, the computing device 110 updates, based on the second performance metric, the second performance corresponding to the target causal model configuration. Due to the presence of the ground truth causal model in the training process, the performance of the ground truth causal model and the causal model built based on the target causal model configuration may be compared, so as to update the second performance corresponding to the target causal model configuration through any suitable probabilistic matching algorithms (such as softmax and the like).

For example, the second performance corresponding to the target causal model configuration may be updated via the following equation:

p(k)=e^{μ(k)}/Σ₁^{K}e^{μ(k)/T} (1)

Where k denotes causal model configuration, p(k) denotes the second performance of the causal model configuration k, e denotes a natural constant, μ(k) denotes the second performance metric of the causal model configuration k, and T denotes temperature.

In this way, the adaptive causal model configuration selector may be implemented to select a suitable causal model configuration for building a good causal model.

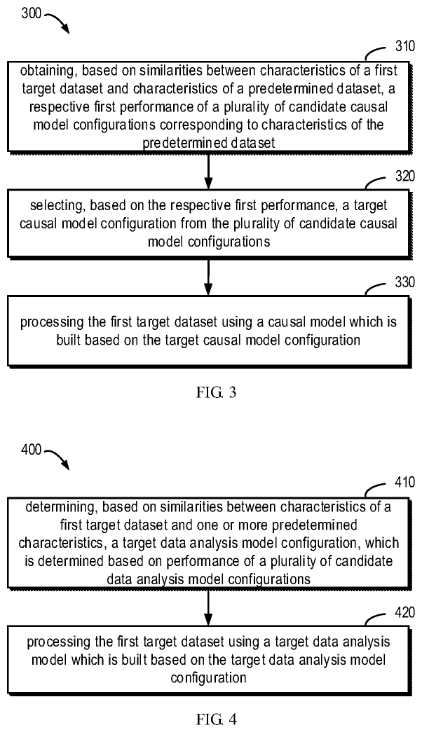

The exemplary training procedure of the selector 150 has been described above with reference to FIG. 2. An exemplary use procedure of the selector 150 is to be depicted with reference to FIG. 3 below.

FIG. 3 illustrates a flow chart of an exemplary use procedure 300 in accordance with embodiments of the present disclosure. For example, the method 300 may be executed by the computing device 110 shown in FIG. 1. It should be understood that the method 300 may also include additional blocks not shown and/or omit some blocks already shown. The scope of the present disclosure is not restricted in this regard.

At block 310, the computing device 110 obtains, based on similarities between characteristics of the first target dataset and characteristics of the predetermined dataset, respective first performance of a plurality of candidate causal model configurations corresponding to the characteristics of the predetermined dataset. The first performance is obtained in a way similar to the second performance. Specifically, in some embodiments, the computing device 110 may obtain a first target dataset, determine characteristics of the first target dataset, determine respective similarities between the characteristics of the first target dataset and the characteristics of a set of candidate predetermined datasets, and select, from the set of candidate predetermined datasets, a candidate predetermined dataset having the highest similarities as a predetermined dataset.

Besides, in some embodiments, the characteristics of the first target dataset may include ratio of binary data in the first target dataset, ratio of continuous data in the first target dataset, ratio of sequencing data in the first target dataset, ratio of categorical data in the first target dataset, characteristic dimensionality of the training dataset, sample count in the first target dataset, ratio of missing data in the first target dataset, balance of target factor values in the first target dataset, structure characteristics built from the first target dataset, skewness of the first target dataset, kurtosis of the first target dataset, mean values of the first target dataset, and variance of the first target dataset etc. The characteristics may also further include characteristics of application fields or application environments of the first target dataset.

Considering that the first performance is obtained in a way similar to the second performance and the characteristics of the first target dataset are similar to those of the training dataset, the detailed description is not provided here.

However, unlike the second performance which is predetermined in the training procedure, the first performance is iteratively updated in the use procedure. This is because the second performance determined in the training procedure may fail to adapt to the actual situations, and thus the real feedback from interactions with the environment is crucial here. The real feedback may be used for correcting selection of the target causal model configuration. The second performance is estimated or calculated in the training procedure and is fixed during use procedure, so the second performance may be considered as static performance. By contrast, the first performance is determined and updated based on the real feedback in the use procedure, so it is regarded as dynamic performance.

In some embodiments, the first performance may initially be set to a predetermined value (e.g., 0 or any other suitable values, such as a value determined based on the second performance or experience) and is further dynamically updated during use procedure. The updation of the first performance will be described in details below.

In addition, an example of respective first performance of a plurality of candidate causal model configurations corresponding to the characteristics of the set of candidate predetermined datasets is illustrated in Table 2 below:

TABLE 2

| | Causal Model Method 1 | | Causal Model Method 2 | |
|---|---|---|---|---|
| | Parameter 1 | Parameter 2 | Parameter 3 | Parameter 4 |
| Candidate | 0.3 | 0.3 | 0.12 | 0.28 |
| predetermined | | | | |
| dataset 1 | | | | |
| Candidate | 0.4 | 0.1 | 0.25 | 0.25 |
| predetermined | | | | |
| dataset 2 | | | | |

Accordingly, for the candidate predetermined dataset 1, the first performance of the causal model configuration (causal model method 1 and parameter 1) is 0.3, the first performance of the causal model configuration (causal model method 1 and parameter 2) is 0.3, the first performance of the causal model configuration (causal model method 2 and parameter 3) is 0.12 and the first performance of the causal model configuration (causal model method 2 and parameter 4) is 0.28. Similarly, for the candidate predetermined dataset 2, the first performance of the causal model configuration (causal model method 1 and parameter 1) is 0.4, the first performance of the causal model configuration (causal model method 1 and parameter 2) is 0.1, the first performance of the causal model configuration (causal model method 2 and parameter 3) is 0.25 and the first performance of the causal model configuration (causal model method 2 and parameter 4) is 0.25.

Assuming the candidate predetermined dataset 2 is determined as the predetermined dataset, then the respective first performance of a plurality of candidate causal model configurations corresponding to the candidate predetermined dataset 2 will be obtained. As stated above, for the candidate predetermined dataset 2, the first performance of the causal model configuration (causal model method 1 and parameter 1) is 0.4, the first performance of the causal model configuration (causal model method 1 and parameter 2) is 0.1, the first performance of the causal model configuration (causal model method 2 and parameter 3) is 0.25 and the first performance of the causal model configuration (causal model method 2 and parameter 4) is 0.25.

Besides, it should be understood that although Table 2 only demonstrates four causal model configurations and two candidate predetermined datasets, any suitable causal model configurations and candidate predetermined datasets are also feasible. In addition, although the first performance of each candidate predetermined dataset is normalized, i.e., the first performance of each causal model configuration is summed to 1, the first performance may also not be normalized.

At block 320, the computing device 110 selects, based on the respective first performance, a target causal model configuration from a plurality of candidate causal model configurations. For example, a candidate causal model configuration having the highest first performance may be selected as the target causal model configuration. As stated above, among the four causal model configurations, the candidate causal model configuration (causal model method 1 and parameter 1) has the highest first performance of 0.4 and is accordingly selected as the target causal model configuration. For example, the target causal model configuration may be “{alg=‘GES’, ‘maxDegree’=2}”, “{alg=‘PC’, ‘alpha’=0.2, ‘numCores’=2}” and the like.

Moreover, in some embodiments, the second performance may also be considered besides the first performance. Specifically, the computing device 110 may obtain a respective second performance of a plurality of candidate causal model configurations corresponding to the characteristics of the predetermined datasets, and select, based on the respective first performance and the second respective performance, a target causal model configuration from a plurality of candidate causal model configurations.

Furthermore, in some embodiments, in order to select the target causal model configuration based on the respective first performance and the second respective performance, the computing device 110 may determine, for each of a plurality of candidate causal model configurations, the number of times a plurality of candidate causal model configurations is used for building the causal model and the number of times the candidate causal model configuration is employed for building the causal model, which may also be collectively referred to as total number of times. The computing device 110 may determine a performance indicator of the candidate causal model configuration in accordance with the number of times a plurality of candidate causal model configurations are used for building the causal model, the number of times the candidate causal model configuration is employed for building the causal model as well as the first and second performance of the candidate causal model configuration.

Thus, the computing device 110 may select, from a plurality of candidate causal model configurations, a candidate causal model configuration having the highest performance indicator as the target casual model configuration.

For example, the selecting the target casual model configuration may follow the equation (2) below:

$$k = {arg max}_{k} \{ v ( k ) + c \cdot p ( k ) \frac{\sqrt{N}}{1 + N ( k )} \} \qquad ( 2 )$$

Where k denotes causal model configuration, argmax denotes a function for the optimal configuration of the target function, v(k) denotes first performance, c denotes weight, p(k) denotes second performance, N denotes the number of times a plurality of candidate causal model configurations are used for building the causal model, and N(k) denotes the number of times a particular candidate causal model configuration is used for building the causal model.

At block 330, the computing device 110 processes the first target dataset using the causal model which is built based on the target causal model configuration. The processing includes but not limited to one or more of: (1) analyzing causal relationships of the first target dataset; (2) predicting target factors using the obtained causal relationships; and (3) outputting the obtained causal graph.

In some embodiments, the computing device 110 may acquire a user request that specifies a constraint associated with target factors. For example, the user request may include possible data intervention sets, feasible ranges of all nodes in the causal graph, objective function(s) and constraints, as well as the budget for calculating the optimal strategy. As an example, the user request may specify an at least 10% increase of corporate profit while the budget growth is constrained within 1%. Additionally, in some embodiments, the computing device 110 may also convert the user request into a programmable language for subsequent processing.

The computing device 110 may determine, based on the user request and the causal model, one or more target strategies to be applied to the first target dataset. For example, in a scenario related to customer satisfaction with telecommunication operators, the target factor for example is “customer satisfaction” and there are various reasons for the target factor of “customer satisfaction” (e.g., reminder before the package runs up and discount package etc.). A corresponding strategy may be formulated based on these factors (e.g., by providing to the customer more reminders triggered by software before the package runs up or giving more discount package options to the customer) to increase customer satisfaction with the telecommunication operators.

As stated above, the first performance is iteratively updated during use procedure. In some embodiments, the computing device 110 may determine variations of target factors resulted from applying a strategy to a further target dataset (hereinafter referred to as “second target dataset”). The second target dataset is a dataset collected when the strategy is being executed. Variations of the target factors, for example, may be increasing the customer satisfaction by 4% or raising the profit by 20% etc. The computing device 110 may update, based on the variations of the target factors, the first performance corresponding to the target causal model configuration. The variations of the target factors may be observed real or actual changes of the target factors.

In some embodiments, in order to update the first performance corresponding to the target causal model configuration, the computing device 110 may determine the number of times the target causal model configuration is applied to build the causal model. The computing device 110 may update the first performance corresponding to the target causal model configuration according to the real changes of the target factors and the number of times the target causal model configuration is applied to build the causal model.

For example, the first performance corresponding to the target causal model configuration may be updated according to the following equation (3):

v_{new}(k)=v_{old}(k)+(r+v_{old}(k))/N(k) (3)

Wherein v_{new}(k) denotes the updated first performance, N(k) denotes the number of times the target causal model configuration is applied to build the causal model, k denotes the causal model configuration, r denotes real changes of the target factors, and v_{old}(k) denotes the current first performance. It is to be understood that the determined v_{new}(k) in the previous iteration serves as v_{old}(k) in the next iteration.

In this way, an adaptive causal model configuration selector may be implemented, enabling the system to comprehensively consider samples and actual feedback of the causal model configuration in the training procedure. As such, a system is provided for self-optimizing causal analysis and deployable intervention as a service by automatically improving the quality of decision making. In addition, a general decision-making framework for optimal intervention may also be fulfilled to support linear/nonlinear causal models, multi-objective, multi-treatment, subgroup budgets, and subpopulation decision-making etc.

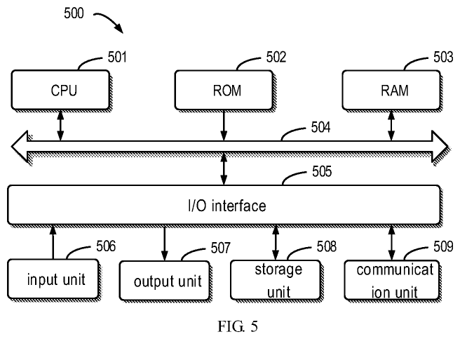

FIG. 4 illustrates a flow chart of an exemplary use procedure 400 in accordance with embodiments of the present disclosure. For example, the method 400 may be executed by the computing device 110 shown in FIG. 1. It should be understood that the method 400 may also include additional blocks not shown and/or omit some blocks already shown. The scope of the present disclosure is not restricted in this regard.

At block 410, the computing device 110 determines, based on the similarities between the characteristics of the first target dataset and one or more predetermined features, a target data analysis model configuration. The target data analysis model configuration is determined according to the performance of a plurality of candidate data analysis model configurations. The characteristics have been elaborated in the previous text and thus will not be repeated here. Besides, the data analysis model configuration may be any suitable configurations of the data analysis model, e.g., various suitable machine learning models, neural network models and the like. Accordingly, at block 420, the computing device 110 processes the first target dataset using a target data analysis model built based on the target data analysis model configuration. The first target dataset may include, but not limited to, images, audio and text among other data. The data analysis model may include, but not limited to, one or more of category model, identification model, prediction model and causal analysis model. It is to be noted that the method 400 may cover method 300, so the details of the method 400 are omitted here.

In some embodiments, the computing device includes a circuit configured to execute operations of: obtaining, based on similarities between characteristics of a first target dataset and characteristics of a predetermined dataset, a respective first performance of a plurality of candidate causal model configurations corresponding to characteristics of the predetermined dataset; selecting, based on the respective first performance, a target causal model configuration from the plurality of candidate causal model configurations; and processing the first target dataset using a causal model built based on the target causal model configuration.

In some embodiments, the computing device also includes a circuit configured to execute operations of: obtaining the first target dataset; determining characteristics of the first target dataset; determining the similarities between characteristics of the first target dataset and characteristics of a set of candidate predetermined datasets; and selecting, from the set of candidate predetermined datasets, a candidate predetermined dataset having the highest similarities as the predetermined dataset.

In some embodiments, the characteristics include at least one of: ratio of binary data in the first target dataset, ratio of continuous data in the first target dataset, ratio of sequencing data in the first target dataset, ratio of categorical data in the first target dataset, characteristic dimensionality of the first target dataset, sample count in the first target dataset, ratio of missing data in the first target dataset, balance of target factor values in the first target dataset, structure characteristics built from the first target dataset, skewness of the first target dataset, kurtosis of the first target dataset, mean value of the first target dataset, and variance of the first target dataset.

In some embodiments, the computing device also includes a circuitry configured to execute the following operations of: obtaining a respective second performance of the plurality of candidate causal model configurations corresponding to characteristics of the predetermined dataset; and selecting, based on the respective first performance and the respective second performance, the target causal model configuration from the plurality of candidate causal model configurations.

In some embodiments, the computing device also includes a circuitry configured to execute the following operations of: for each candidate causal model configuration of the plurality of candidate causal model configurations, determining the number of times the plurality of candidate causal model configurations are used for building a casual model; determining the number of times the candidate causal model configuration is used for building a causal model; determining a performance indicator of the candidate causal model configuration based on the number of times the plurality of candidate causal model configurations are used for building a casual model, the number of times the candidate causal model configuration is used for building a causal model, first performance of the candidate causal model configuration and second performance of the candidate causal model configuration; and selecting, from the plurality of candidate causal model configurations, a candidate causal model configuration having the highest performance indicator as the target causal model configuration.

In some embodiments, the computing device also includes a circuit configured to execute operations of: obtaining a user request that assigns a constraint associated with the target factor; and determining, based on the user request and the causal model, one or more target strategies to be applied to the first target dataset.

In some embodiments, the computing device also includes a circuitry configured to execute operations of: determining changes of target factor resulted from applying the strategy to the second target dataset; and updating, based on changes of the target factor, first performance corresponding to the target causal model configuration.

In some embodiments, the computing device also includes a circuitry configured to execute operations of: determining the number of times the target causal model configuration is used for building the causal model; and updating, based on changes of the target factor and the number of times the target causal model configuration is used for building the causal model, first performance corresponding to the target causal model configuration.

In some embodiments, the target causal model configuration includes at least one of: causal model method, and parameters of causal model method.

In some embodiments, the computing device also includes a circuitry configured to execute the following operations of: obtaining, based on similarities between a training dataset and a predetermined dataset, a respective second performance of a plurality of candidate causal model configurations corresponding to characteristics of the predetermined dataset; selecting, based on the respective second performance, a target causal model configuration from the plurality of candidate causal model configurations; determining a second performance metric resulted from applying a causal model to the training dataset, the causal model being built based on the target causal model configuration; and updating, based on the second performance metric, a second performance corresponding to the target causal model configuration.

In some embodiments, the computing device also includes a circuitry configured to execute the following operations of: obtaining the training dataset; determining characteristics of the training dataset; determining corresponding similarities between characteristics of the training dataset and characteristics of a set of candidate predetermined datasets; and selecting, from the set of candidate predetermined datasets, a candidate predetermined dataset having the highest similarities as the predetermined dataset.

In some embodiments, the computing device also includes a circuitry configured to execute the following operations of: if similarities between the training dataset and each predetermined dataset in the set of candidate predetermined datasets are below a predetermined threshold, adding characteristics of the training dataset into characteristics of the set of candidate predetermined datasets; and setting the second performance of the plurality of candidate causal model configurations corresponding to characteristics of the training dataset as a predetermined second performance.

In some embodiments, the computing device also includes a circuitry configured to execute operations of: determining the number of times the plurality of candidate causal model configurations are used for building a causal model; and determining the predetermined threshold based on the number of times.

In some embodiments, the second performance metric includes at least one of: category precision, recall rate, and F1 score.

In some embodiments, the target causal model configuration includes at least one of: causal model method; and parameters of causal model method.

In some embodiments, the computing device also includes a circuitry configured to execute the following operations of: adding a predetermined causal model configuration into the plurality of candidate causal model configurations based on the number of times the plurality of candidate causal model configurations are used for building a causal model.

In some embodiments, the computing device also includes a circuitry configured to execute operations of: determining, based on similarities between characteristics of a first target dataset and one or more predetermined characteristics, a target data analysis model configuration, which is determined based on performance of a plurality of candidate data analysis model configurations; and processing the first target dataset using a target data analysis model which is built based on a target data analysis model configuration.

FIG. 5 illustrates a schematic block diagram of an example device 500 for implementing embodiments of the present disclosure. For example, the computing device 110 shown in FIG. 1 may be implemented by the device 500. As shown in FIG. 5, the device 500 comprises a central process unit (CPU) 501, which can execute various suitable actions and processing based on the computer program instructions stored in the read-only memory (ROM) 502 or computer program instructions loaded in the random-access memory (RAM) 503. The RAM 503 can also store all kinds of programs and data required by the operation of the device 1000. CPU 501, ROM 502 and RAM 503 are connected to each other via a bus 504. The input/output (I/O) interface 505 is also connected to the bus 504.

A plurality of components in the device 1000 are connected to the I/O interface 505, such components including: an input unit 506, such as keyboard, mouse and the like; an output unit 507, e.g., various kinds of display and loudspeakers etc.; a storage unit 508, such as disk and optical disk etc.; and a communication unit 509, such as a network card, modem, wireless transceiver and the like. The communication unit 509 allows the device 1000 to exchange information/data with other devices via the computer network, such as Internet, and/or various telecommunication networks.

The processing unit 501 is configured to execute the above described procedure and processing, such as method 200, 300 and/or 400. For example, in some embodiments, the method 200, 300 and/or 400 can be implemented as a computer software program tangibly included in the machine-readable medium, e.g., storage unit 508. In some embodiments, the computer program can be partially or fully loaded and/or mounted to the device 500 via ROM 502 and/or communication unit 509. When the computer program is loaded to RAM 503 and executed by the CPU 501, one or more steps of the above described method 200, 300 and/or 400 can be implemented.

The present disclosure can be implemented as a system, method and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, electrical storage device, magnetic storage device, optical storage device, electromagnetic storage device, semiconductor storage device or any appropriate combinations of the above. More concrete examples of the computer-readable storage medium (non-exhaustive list) include portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions based on instruction set architecture (ISA), machine instructions, machine-related instructions, microcodes, firmware instructions, state setting data, or source codes or target codes written in any combinations of one or more programming languages. The programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or the remote computer can be connected to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions which, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, and the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations are obvious for those skilled in the art, so long as they do not deviate from the scope and spirit of the explained various embodiments. The selection of terms in the text aims to best explain principles and actual applications of each embodiment and technical improvements made in the market by each embodiment, or enable those ordinary skilled in the art to understand embodiments of the present disclosure.

1-20. (canceled)

21. A method for data processing, comprising:
obtaining, based on similarities between characteristics of a first target dataset and characteristics of a predetermined dataset, a respective first performance of a plurality of candidate causal model configurations corresponding to characteristics of the predetermined dataset;
selecting, based on the respective first performance, a target causal model configuration from the plurality of candidate causal model configurations; and
processing the first target dataset using a causal model which is built based on the target causal model configuration.

22. The method of claim 21, further comprising:
obtaining the first target dataset;
determining characteristics of the first target dataset;
determining corresponding similarities between characteristics of the first target dataset and characteristics of a set of candidate predetermined datasets; and
selecting, from the set of candidate predetermined datasets, a candidate predetermined dataset having the highest similarities as the predetermined dataset.

23. The method of claim 22, wherein the characteristics comprise at least one of:
ratio of binary data in the first target dataset,
ratio of continuous data in the first target dataset,
ratio of sequencing data in the first target dataset,
ratio of categorical data in the first target dataset,
characteristic dimensionality of the first target dataset,
sample count in the first target dataset,
ratio of missing data in the first target dataset,
balance of target factor values in the first target dataset,
structure characteristics built from the first target dataset,
skewness of the first target dataset,
kurtosis of the first target dataset,
mean value of the first target dataset, and
variance of the first target dataset.

24. The method of claim 21, wherein selecting the target causal model configuration comprises:
obtaining a respective second performance of the plurality of candidate causal model configurations corresponding to characteristics of the predetermined dataset; and
selecting, based on the respective first performance and the respective second performance, the target causal model configuration from the plurality of candidate causal model configurations.

25. The method of claim 24, wherein selecting, based on the respective first performance and the respective second performance, the target causal model configuration comprises:
for each candidate causal model configuration in the plurality of candidate causal model configurations,
determining the number of times the plurality of candidate causal model configurations are used for building a casual model,
determining the number of times the candidate causal model configuration is used for building a causal model, and
determining a performance indicator of the candidate causal model configuration based on the number of times the plurality of candidate causal model configurations are used for building a casual model, the number of times the candidate causal model configuration is used for building a causal model, and the first performance of the candidate causal model configuration and the second performance of the candidate causal model configuration; and
selecting, from the plurality of candidate causal model configurations, the candidate causal model configuration having the highest performance indicator as the target causal model configuration.

26. The method of claim 21, further comprising:
obtaining a user request which specifies a constraint associated with the target factor; and
determining, based on the user request and the causal model, one or more target strategies to be applied to the first target dataset.

27. The method of claim 26, further comprising:
determining changes of target factor resulted from applying the strategy to the second target dataset; and
updating, based on changes of the target factor, the first performance corresponding to the target causal model configuration.

28. The method of claim 27, wherein updating the first performance corresponding to the target causal model configuration comprises:
determining the number of times the target causal model configuration is used for building the causal model; and
updating, based on changes of the target factor and the number of times the target causal model configuration is used for building the causal model, the first performance corresponding to the target causal model configuration.

29. The method of claim 21, wherein the target causal model configuration comprises at least one of:
causal model method, and
parameters of causal model method.

30. A method for processing data, comprising:
obtaining, based on similarities between a training dataset and a predetermined dataset, a respective second performance of a plurality of candidate causal model configurations corresponding to characteristics of the predetermined dataset;
selecting, based on the respective second performance, a target causal model configuration from the plurality of candidate causal model configurations;
determining a second performance metric resulted from applying a causal model to the training dataset, the causal model being built based on the target causal model configuration; and
updating, based on the second performance metric, a second performance corresponding to the target causal model configuration.

31. The method of claim 30, further comprising:
obtaining the training dataset;
determining characteristics of the training dataset;
determining corresponding similarities between characteristics of the training dataset and characteristics of a set of candidate predetermined datasets; and
selecting, from the set of candidate predetermined datasets, a candidate predetermined dataset having the highest similarities as the predetermined dataset.

32. The method of claim 30, further comprising:
if similarities between the training dataset and each predetermined dataset in the set of candidate predetermined datasets are lower than a predetermined threshold, adding characteristics of the training dataset into characteristics of the set of candidate predetermined datasets; and
setting the second performance of the plurality of candidate causal model configurations corresponding to characteristics of the training dataset as a predetermined second performance.

33. The method of claim 32, further comprising:
determining the number of times the plurality of candidate causal model configurations are used for building a causal model; and
determining the predetermined threshold based on the number of times.

34. The method of claim 30, the second performance metric comprises at least one of:
category precision,
recall rate, and
F1 score.

35. The method of claim 30, wherein the target causal model configuration comprises at least one of:
causal model method; and
parameters of causal model method.

36. The method of claim 30, further comprising:
adding a predetermined causal model configuration into the plurality of candidate causal model configurations, based on the number of times the plurality of candidate causal model configurations are used for building a causal model.

37. An apparatus for data processing, comprising:
at least one processing unit; and
at least one memory coupled to the at least one processing unit and storing instructions to be executed by the at least one processing unit, the instructions, when executed by the at least one processing unit, causing the apparatus to:
obtain, based on similarities between characteristics of a first target dataset and characteristics of a predetermined dataset, a respective first performance of a plurality of candidate causal model configurations corresponding to characteristics of the predetermined dataset;
select, based on the respective first performance, a target causal model configuration from the plurality of candidate causal model configurations; and
process the first target dataset using a causal model which is built based on the target causal model configuration.

38. The apparatus of claim 37, wherein the apparatus is further caused to:
obtain the first target dataset;
determine characteristics of the first target dataset;
determine corresponding similarities between characteristics of the first target dataset and characteristics of a set of candidate predetermined datasets; and
select, from the set of candidate predetermined datasets, a candidate predetermined dataset having the highest similarities as the predetermined dataset.

39. The apparatus of claim 38, wherein the characteristics comprise at least one of:
ratio of binary data in the first target dataset,
ratio of continuous data in the first target dataset,
ratio of sequencing data in the first target dataset,
ratio of categorical data in the first target dataset,
characteristic dimensionality of the first target dataset,
sample count in the first target dataset,
ratio of missing data in the first target dataset,
balance of target factor values in the first target dataset,
structure characteristics built from the first target dataset,
skewness of the first target dataset,
kurtosis of the first target dataset,
mean value of the first target dataset, and
variance of the first target dataset.

40. The apparatus of claim 37, wherein the apparatus is caused to select the target causal model configuration by:
obtaining a respective second performance of the plurality of candidate causal model configurations corresponding to characteristics of the predetermined dataset; and
selecting, based on the respective first performance and the respective second performance, the target causal model configuration from the plurality of candidate causal model configurations.
